(19) United States
(12) Patent Application Publication
(10) Pub. No.: US 2007/0285312 A1
(43) Pub. Date: Dec. 13, 2007

(54) Adaptive multi-beam system

(75) Inventors: Shiwei Gao, Nepean (CA); Hafedh Trigui, Ottawa (CA)

Correspondence Address: Lawrence G. Kurland, Esq.;BRYAN CAVE LLP, 1290 Avenue of the Americas, New York, NY, 10104-3300, US

(73) Assignee: TenXc Wireless Inc.

(21) Appl. No.: 11/784,485

(22) Filed: Apr. 6, 2007

(30) Foreign Application Priority Data
Apr. 7, 2006 (CA) 2,542,445

(51) Int. Cl. H04B 7/26

(52) U.S. Cl. 342/367

(57) ABSTRACT

A system and method of providing an adaptive multi-beam capability to a wireless base transceiver station is disclosed. The system comprises a plurality of transmit and receive antenna arrays and a plurality of static beamformers to form a limited number of beams. The beam data is reduced to digital baseband form whereupon it is digitally beamformed using a set of adaptive beamforming weights generated having regard to the form and content of the data and the environment. Such form and content information is obtained directly or indirectly from the base transceiver station. The weights are calculated using an average power function derived from a correlation of the beam data with a reference signal that mimics the training sequence assigned to the base transceiver station. Because the average power does not vary widely from frame to frame, the weights derived from the uplink direction may be reapplied in the downlink direction. Specific provision is made for data packets, where downlink packets may contain control information intended for broadcast to all subscribers.

### CROSS REFERENCE TO RELATED APPLICATIONS

This application claims the benefit of Canadian Patent Application No. 2,542,445 filed Apr. 7, 2006, which disclosure is incorporated herein by reference in its entirety.

### BACKGROUND TO THE INVENTION

1. Field of the Invention

The present invention relates to wireless communications and in particular to an adaptive multi-beam antenna system.

2. Description of the Prior Art

In wireless communication systems, the frequency spectrum is a scarce resource that must be used efficiently.

One idea for increasing capacity in the face of this resource constraint was to divide a geographic area into smaller regions or cells, and to restrict each cell to a limited number of channels. Depending upon the access technique employed in the system, frequency channels may or may not be re-used in adjacent cells.

For frequency division multiple access (FDMA) systems, such as the GSM standard, it is preferred that adjacent cells do not use the same frequency channels, in order to mitigate co-channel interference. Rather, in order to maintain a minimum quality of service, which is related to signal to noise plus interference ratio (SINR), a minimum distance is maintained between cells deploying the same frequency channels. Therefore, the total frequency spectrum is divided into smaller sets of frequencies and every set of frequency channels is re-sued in different cells of a cellular network.

Were a frequency channel to be assigned to a single user, the capacity of the cell, that is, the number of users that could be supported by the cell, would be equal to the number of frequency channels assigned to the cell, which is very limited.

In order to further increase capacity, some systems, such as the GSM standard, also employ time division multiple access (TDMA) techniques, so that a particular user transmits and/or receives in a limited number of periodic time intervals or packets. In the GSM system, the time is divided into frames of 8 packets or time slots. Thus, 8 users could share a single frequency channel without any risk of interference. The maximum number of users per cell that could be simultaneously connected (slots) is then the product of the number of frequency channels and the number of time slots (8).

In wireless communications, there are typically two communications links between a base transceiver station (BTS) and the mobile station (MS) or handheld. These are referred to as the forward or downlink (DL) direction from the BTS to the MS and the reverse or uplink (UL) direction from the MS to the BTS.

The allocated frequency channels per cell could conceivably be used for both uplink and downlink directions, such as in the so-called time division duplex (TDD) systems. In such a case, the potential capacity discussed above is not achieved because the total number of slots must be shared between the uplink and downlink directions.

In order to be able to allocate all of the slots to a single link, one would double the number of frequency channels per cell, because the number of time slots is set by the communication standard. Then, half of the frequency channels would be used for one direction and the remainder for the complementary direction, such as in the so-called frequency division duplex (FDD) systems, such as the GSM system.

From an implementation point of view, two antennas could be used for an FDD system, namely a receive antenna and a transmit antenna. Alternatively, a single antenna could be used for both transmit and receive purposes, but then some mechanism to separate the transmit and the receive chains, such as a duplexer and filters, would be called for.

In early deployments of cellular systems, the antenna generated a constant radiation pattern that covered the cell region in an omni-directional pattern. As such, the antenna was mounted in the centre of the cell and transmitted constant power in all directions. The maximum reach of the cell depended upon a number of parameters, such as propagation environment, transmit power and losses in the transmit chain. Given a certain cell size, one optimized the transmit power of the antenna to cover the cell and to reduce any radiation to adjacent cells.

Later generations of cellular base station technology introduced the concept of sectorization as a means of increasing capacity. In a sectorized system, the antenna made directional, with a specified beam width. Thus, the cell size (or the coverage area) is limited not only by the maximum reach, but also by the angular spacing. Conceptually, if the cell coverage area of an omni-directional antenna was represented by a circular disk, that of a directional antenna would be a segment of the disk. Typical beamwidths of directional antennas are 33°, 45°, 65°, 85°, 90° and 105°, however, in theory, an antenna could be designed for any desired beam width.

Sectorization not only increases the capacity by decreasing interference, but it also decreases the capital cost of installing base stations, as a particular antenna site could house a plurality of outward facing sectors.

Currently, a tri-sectorization approach, with the cell being split into three sectors of typically 120° per sector is widely deployed. To cover each sector, an antenna with a 65° beam width is used.

From the point of view of reduction of interference, it is generally preferable to introduce a higher degree of sectorization. However, higher sectorization may be challenging for previously known communications systems because there is only limited room for change. As well, practically, there is an upper limit to the amount of sectorization, probably on the order of 6 sectors. With higher sectorization, the number of users being in a handover situation between sectors, and thus the overhead cost, also increases because the sectors are narrower.

Therefore, when this upper limit is reached or approached, the options remaining for further increasing user capacity are limited. One such option is beamforming, also known generically as spatial filtering, or colloquially, smart antennas. In beamforming, a narrow beam is generated and pointed to a desired user. In some instances, the beam pattern may be altered over time to track the motion of the desired user through the sector or cell.

The idea behind beamforming (in the uplink direction) is to receive multiple copies of the signal through multiple antenna elements and to combine them in such a way as to increase the signal to noise ratio (SNR) (or the SINR, which is probably a better criterion, having regard to the major concern of dealing with co-channel interference). Generally, one such way is to systematically introduce nulls in the direction of co-channel interferers.

In the uplink direction, the data packet itself contains information known to the receiver. This information can be used to estimate the vector (magnitudes and phases) of weights necessary to combine the received antenna signals in a way to form a beam toward the desired user and/or nulls toward undesired users.

For TDD systems, where a mobile handheld communicates in both directions along the same channel frequency, the weights computed in the uplink direction could be re-used in the downlink direction because it may be safely assumed that the propagation environment will remain relatively constant across a short time interval.

However, for FDD systems, only the channel parameters in the uplink direction will be capable of estimation. These, unfortunately, are uncorrelated with the parameters in the downlink direction. Nevertheless, others of the available uplink channel parameters may not be different for the downlink across a short time interval. For example, the direction of arrival (DoA), time of arrival (ToA) and averaged powers in the uplink direction are very likely to remain unchanged within a short time period. Because they are related to the physical position of the mobile handheld, they ought similarly to be applicable to the downlink channel as well.

Accordingly, one strategy to estimate the appropriate weights for the downlink channel might be build these estimated weights based on these substantially time invariant parameters, in order to reproduce the desired nulls and/or appropriately steer the generated beams.

Unfortunately, it is well known that the state of the art methods of so doing suffer from lack of robustness. Accordingly, any error in the calibration of the antenna array or any motion on the part of a co-channel interferer will translate in an undesired shift of a null location. Provided, however, that the undesired angular shift remains small, the degradation in the beamforming performance may not be significant.

An initial implementation of smart antenna technology involved a switched beam architecture, as shown in FIG. 1. This architecture boasts relative simplicity of design and was easily made inter-operable with existing standards and systems.

The switched beam architecture used a Butler matrix to combine the received signals (in the uplink direction) on the antenna elements. Because of the nature of a Butler matrix, the number of combined signals is typically equal to the number of antenna array columns. As such, the signals on the beams would be highly correlated and it is relatively challenging to discriminate between desired weak and strong noise signals.

In practice, it is more likely that the number of combined antenna signals do not exceed the number of antenna array columns. Since only a limited number of signal paths are designed and processed in parallel, this results in a reduced complexity design.

In the uplink direction, a decision regarding the signal path to be processed could simply be based upon power measurements where there is a low probability of occurrence of interfering signals.

In particular, for a specific geographic location of the mobile transmitter within a sector, it is unlikely that a single beam will capture all of the dominant components of the received signal. For example, in other circumstances, such as high multi-path environments and inter-beam handover situations, such as is often encountered by wireless communications systems in dense urban environments, other minor components may fall within a second beam. Unfortunately, typical switched beam systems only consider a single beam to process a desired signal. Accordingly, the attendant simplification of design of such systems results in a degradation of the system performance.

Further, beam selection based solely on power measurements, as in the switched beam systems, may not be satisfactory because it is possible that one locks onto a strong interfering signal rather than the desired user signal.

Moreover, those having ordinary skill in this art will recognize that a switched beam system will not cancel an interfering signal that shares the same beam as the desired signal.

Even if the interfering signal and the desired signal do not share the same beam, in a switched beam system, the interfering signal will only be attenuated in relation to the angular direction of the interfering signal relative to the direction of the desired signal.

When the desired user is spatially located between two adjacent beams, one would expect an average signal loss of around 3 to 4 dB. One could compensate for such loss by power control, but the transmission of excess power may cause corresponding interference to other cells in the network. If compensation is not made for this, the crossover loss would reduce the anticipated beamforming gain or equivalently the coverage gain.

On the other hand, because, in a switched beam system, the signals on the beam nodes are not combined, no calibration circuitry will be used to compensate for any phase and/or amplitude imbalance between detected signal paths.

While applying the switched beam methodology to the uplink direction will enhance the BTS+ sensitivity and result in coverage improvement, to get the full benefit of the technology vis-à-vis increasing the number of subscribers that can be handled in the coverage area, the methodology is also applied to the downlink direction.

In the switched beam system, this is relatively straightforward. Assuming that the DoA in the uplink direction will be the same as in the downlink direction, the beam chosen for the uplink can simply be applied in the downlink direction.

A second smart antenna implementation is a phased array system such as is shown in FIG. 2. Unlike the switched beam implementation, where the narrow beams are fixed and thus do not perfectly track a mobile user, a phased array system can dynamically steer the narrow beam toward the desired user simply by altering the phases of the antenna array columns.

As well, by applying non-uniform weighting on the antenna array columns, the width of the steered beam may be varied as well.

Thus, when compared to the switched beam system, the phased array implementation deals with the problem of crossover loss by ensuring that the beam is constantly pointed in the desired user's direction.

Furthermore, by implementing amplitude tapering, the phased array system may outperform switched beam systems in a dense multi-path environment, by widening the beam and thus capturing all of the dominant signal components.

Typically, the narrow beams and phase shifters of a phased array system are implemented in the RF domain. Therefore, some logic is used to tune the receiver and the transmitter in the direction of the desired user. In many communications systems following a standard protocol, a scanning receiver is used to generate the required logic from an analysis of the received signal paths.

However, when tracking a desired signal in more than one of frequency, time and code, it is more appropriate that the scanning receiver processes digital baseband signals, so that down conversion of the received RF signals to IF and baseband would be called for.

A third smart antenna technology is known as adaptive null steering, shown in FIG. 3, in which sharp nulls are generated and steered in the directions of unwanted signals, with the constraint of allowing the desired signal to pass through without degradation. Thus, all of the multi-path components of the desired signal are exploited for improved performance.

Typically, adaptive null steering systems solve for weights using a SINR maximization criterion. The rate of adaptation will generally depend upon the environment. For fixed wireless standards, it is preferable to permanently form a null in the direction of a known strong interferer. In such cases, it may be sufficient to use a few phase shifters, couplers and power combiners in a simple implementation. Such an implementation may also be sufficient in systems applying wireless communications standards in which radio propagation results in a few preferred clustered directions for interfering signals.

In general, the null steering system could be made to adapt at a much higher rate so as to be able to handle the dynamics of desired and interfering signals. However, null steering uses some intelligence about the direction of the desired and interfering signals. Therefore, except for the above-referenced specific examples where static measurements may be sufficient, some sort of DoA estimation and a mapping of the estimates to the desired and interfering signal components may be appropriate.

Such DoA estimation is more easily made in the baseband domain and those having ordinary skill in this art will readily recognize methods for so doing this.

Although in theory, null steering offers an optimal SINR, it may nevertheless not provide an optimal or even the most practical implementation for systems complying with existing wireless communications standards.

For example, in code-division multiple access (CDMA) systems, the spatial correlation of the received signals tends to be white rather than coloured. Accordingly, a simpler implementation, similar to the two-dimensional Rake receiver, might in fact be a more optimal solution. Moreover, the complexity of null steering systems may render them unaffordable when applied to all of the active subscribers in a cellular sector.

In the case of GSM systems, existing features such as slow frequency hopping (SFH) and discontinuous transmission (DTX) may similarly dramatically complicate an implementation of a null steering system.

Under slow frequency hopping conditions, there is no simple means of detecting interfering signal directions, because the downlink direction precedes the uplink direction and changes as to which signals will be interfering will occur for each frame.

Under discontinuous transmission conditions, only limited information will be available to estimate the DoA of the desired and interfering signals. This limited information may be insufficient to derive proper null steering algorithms. The problem would be considerably exacerbated if slow frequency hopping is also deployed.

Furthermore since null steering systems introduce sharp nulls toward interfering signals, the system circuitry is very tightly calibrated in terms of phase and amplitude, in order to ensure that there is only a negligible imbalance between paths.

Accordingly, there is still a need to provide the system performance benefit of beamforming technology while maintaining system complexity and cost to a manageable level.

Conceivably, one could achieve this by reducing the number of signal paths in a beamforming system. If, however, one were to map antenna signals into a reduced number of beam signals, and work in beam space rather than element space, a constraint arises, namely that the number of transceivers would be multiplied by the number of narrow beams.

In a GSM-compliant system, conventional base transceiver stations can be considered to be a narrowband implementation in the sense that every transceiver is tuned to transmit and receive on a single 200 kHz channel. However, when the number of transceivers is very high, multiplying this number by the number of beam nodes would result in an unacceptably large number of RF feeders, and ancillary equipment.

### SUMMARY OF THE INVENTION

Accordingly it is desirable to provide an adaptive multi-beam system compatible with GSM and similar standards that is manageable from both a cost and a system complexity point of view.

The present invention achieves this aim by implementing narrow band receivers together with a wideband receiver/transmitter capable of processing a predetermined frequency band in order to provide efficient channelization to process a large number of channels with only a limited number of receivers.

In effect, the system comprises at least one receive antenna (either a single antenna or else a main and a diversity antenna) attached to at least one corresponding beamforming network. The at least one beamforming network transforms the received signals into beam signals, using fixed beamforming weights that are generally wideband in the sense that the radiation patterns do not vary dramatically across the supported frequency band. The beam signals are down-converted and digitized for processing by a digital signal processor, where they are analyzed in conjunction with knowledge as for the form and content of the data, to determine which, or which arrangement, of the fixed narrow beams provides an optimal signal quality in terms of signal strength and/or lack of co-channel interference, and generates a series of complex weights defining the optimal arrangement on the basis of substantially time-invariant channel parameters such as average power. In effect, the digital signal processor beamforms the beamformed received signals. The receive data thus optimally obtained may then be processed in conventional manner. If the system is an appliqué system, this comprises upconverting the data and transforming it back into analog form.

The complex weights, or at least the underlying criteria, are then used for the transmit channel. The transmit data in digital baseband form (whether originally so in an embedded system or downconverted and digitized upon receipt from a BTS in an appliqué system) is combined in accordance with the complex weights by a digital signal processor and then forwarded to a beamforming network where they are formed into fixed narrow beams for transmission by a transmit antenna array. Because it is assumed that the desired mobile subscriber does not move relative to the antenna arrays between the receive and the transmit time, the same complex weights may be used to maximize the signal received by the mobile subscriber.

The inventive system thus represents a cost-effective smart antenna system.

The inventive system comprises an antenna array and an adaptive processor module. In an embedded system, the adaptive processor is integrated within the base transceiver station itself. Alternatively, the adaptive processor could be configured in an appliqué system together with a transmit aggregation module to interconnect with a conventional base transceiver station.

The present invention may support either narrowband or wideband transceiver technologies. Furthermore, the present invention may be adapted to handle both passive antenna arrays, and so-called active antenna arrays. In passive antenna arrays, external power amplifiers (PAs) and low-noise amplifiers (LNAs) are applied to amplify the transmit and receive signals. In active antenna arrays, the PAs and LNAs are integrated within the antenna array itself. Typically, a larger number of smaller versions of the electronics are used.

The present invention copes with the issue of components of the desired signal falling outside a single beam and proposes methods to improve the system's performance.

According to a first broad aspect of an embodiment of the present invention there is disclosed an adaptive multi-beam system associated with a base transceiver station for transmitting transmit data to and receiving receive data from a mobile subscriber of the base transceiver station, comprising:
at least one receive antenna array of antenna elements adapted to receive analog radio frequency (RF) receive signals containing the receive data;
a receive beamforming network adapted to receive the analog RF receive signals and to generate at least one fixed narrow received beam therefrom;
an information source for providing information on the form and content of the transmit and receive data;
a receive adaptive processor sub-system adapted to receive the at least one fixed narrow received beam, to convert the at least one fixed narrow received beam into received beam data, to generate a plurality of receive adaptive weights from at least one substantially time-invariant parameter of a channel between the mobile subscriber and the at least one receive antenna array, using form and content information of the receive data from the information source, whereby the received beam data is combined to maximize reception of the receive data and/or rejection of undesired signals having a common frequency and time slot therewith, and to forward the combined received beam data to the base transceiver station;
a transmit adaptive processor sub-system adapted to obtain the transmit data from the base transceiver station, to generate transmit adaptive weights from the at least one channel parameter using form and content information of the transmit data and of previous receive data from the information source, to apply the transmit adaptive weights to the transmit data, whereby transmit beam data is generated to maximize reception by the mobile subscriber of the transmit data and/or rejection of undesired signals having a common frequency and time slot;
a transmit beamforming network adapted to receive the transmit beam data and to generate at least one narrow transmit beam therefrom; and
a transmit antenna array of antenna elements adapted to transmit analog RF transmit signals incorporating the at least one narrow transmit beam for receipt by the mobile user.

According to a second broad aspect of an embodiment of the present invention there is disclosed a method of receiving receive data at a base transceiver station having at least one receive antenna array of antenna elements from a mobile subscriber thereof and of transmitting transmit data from the base transceiver station along a transmit antenna array of antenna elements associated therewith to the mobile subscriber, comprising the steps of:
(a) receiving analog RF receive signals containing the receive data at each of the antenna elements of the receive antenna array;
(b) generating at least one fixed narrow receive beam from the analog RF receive signals received at each of the antenna elements of the at least one receive antenna array;
(c) converting each of the at least one fixed narrow receive beam into digital base bend received beam data;
(d) obtaining information on the form and content of the transmit and receive data;
(e) generating a plurality of receive adaptive weights from at least one time-invariant parameter of a channel between the mobile subscriber and the at least one receive antenna array, using the form and content information of the receive data, whereby the received beam data is combined to maximize reception of the receive data and/or rejection of undesired signals having a common frequency and time slot therewith;
(f) forwarding the combined receive data to the base transceiver station;
(g) obtaining the transmit data from the base transceiver station;
(h) generating a plurality of transmit adaptive weights from the at least one channel parameter using the form and content information of the transmit data and of previous receive data, whereby transmit beam data is generated from the transmit adaptive weights and a digital baseband form of the transmit data to maximize reception by the mobile subscriber of the transmit data and/or rejection of undesired signals having a common frequency and time slot;
(i) beamforming the transmit beam data into at least one fixed narrow transmit beam;
(j) forwarding the at least one fixed narrow transmit beam to the antenna elements of the transmit antenna array, and
(k) transmitting, through each of the antenna elements of the transmit antenna array, an analog RF transmit signal incorporating the at least one fixed narrow transmit beam to the mobile subscriber.

Further, the present invention provides robust methods of distinguishing a desired signal from a strong interfering signal.

### BRIEF DESCRIPTION OF THE DRAWINGS

The embodiments of the present invention will now be described by reference to the following figures, in which identical reference numerals in different figures indicate identical elements and in which:

FIG. 1 is a schematic diagram of a switched beam beamforming network of the prior art;

FIG. 2 is a schematic diagram of a phased-array beamforming network of the prior art;

FIG. 3 is a schematic diagram of an adaptive null-steering beamforming network of the prior art;

FIG. 4 is a high-level block diagram of an exemplary embodiment of a wideband appliqué passive antenna implementation of the adaptive multi-beam system of the present invention;

FIG. 5 is a block diagram of the adaptive processor module of FIG. 4;

FIG. 6 is a block diagram of an FPGA structure in the transmit path of FIG. 5 according to the present invention;

FIG. 7 is a block diagram of an FPGA structure in the receive path of FIG. 5 according to the present invention;

FIG. 8 is a timing diagram illustrating salient features of the GSM standard of the prior art;

FIG. 9 is a series of exemplary plots of average power as a function of time in respect of 4 received beams of an active slot;

FIG. 10 is an exemplary drawing illustrating an average power function for inactive super multi-frames in DTX mode;

FIG. 11 is a timing diagram illustrating salient features of an adaptive multi-rate session;

FIG. 12 is a series of exemplary downlink beam coverage patterns suitable for use in a first alternative embodiment of a GPRS/EDGE adaptive multi-beam methodology;

FIG. 13 is a series of exemplary downlink beam coverage patterns suitable for use in a second alternative embodiment of a GPRS/EDGE adaptive multi-beam methodology;

FIG. 14 is a series of exemplary downlink beam coverage patterns suitable for use in a third alternative embodiment of a GPRS/EDGE adaptive multi-beam methodology;

FIG. 15 is a series of exemplary downlink beam coverage patterns suitable for use in a fourth alternative embodiment of a GPRS/EDGE adaptive multi-beam methodology; and

FIG. 16 is an exemplary plot of the beam coverage methodology of FIG. 15, juxtaposed against a sector beam and a best beam methodology.

### DETAILED DESCRIPTION OF THE PREFERRED EMBODIMENT

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

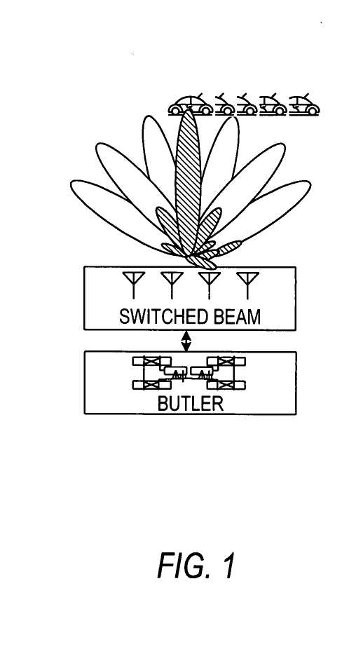

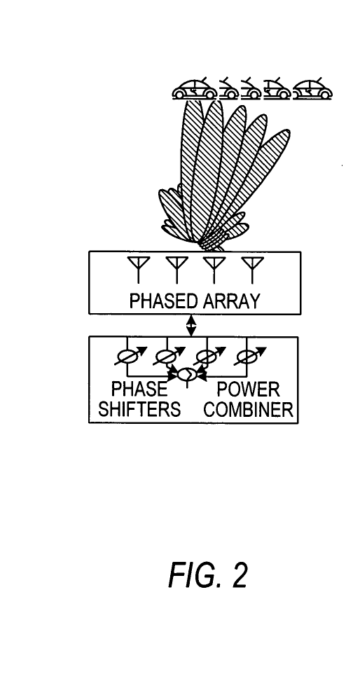

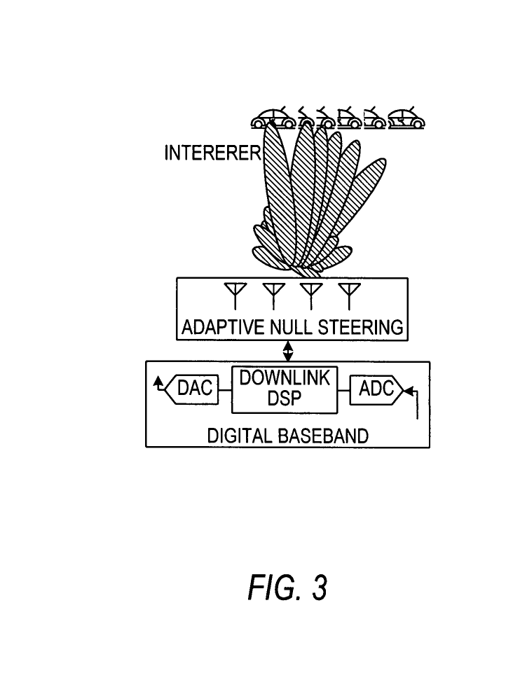

FIGS. 1, 2, and 3 are schematic diagrams of a switched beam beamforming network array, a phased-array beamforming network, and an adaptive null-steering beamforming network of the prior art which have been described above.

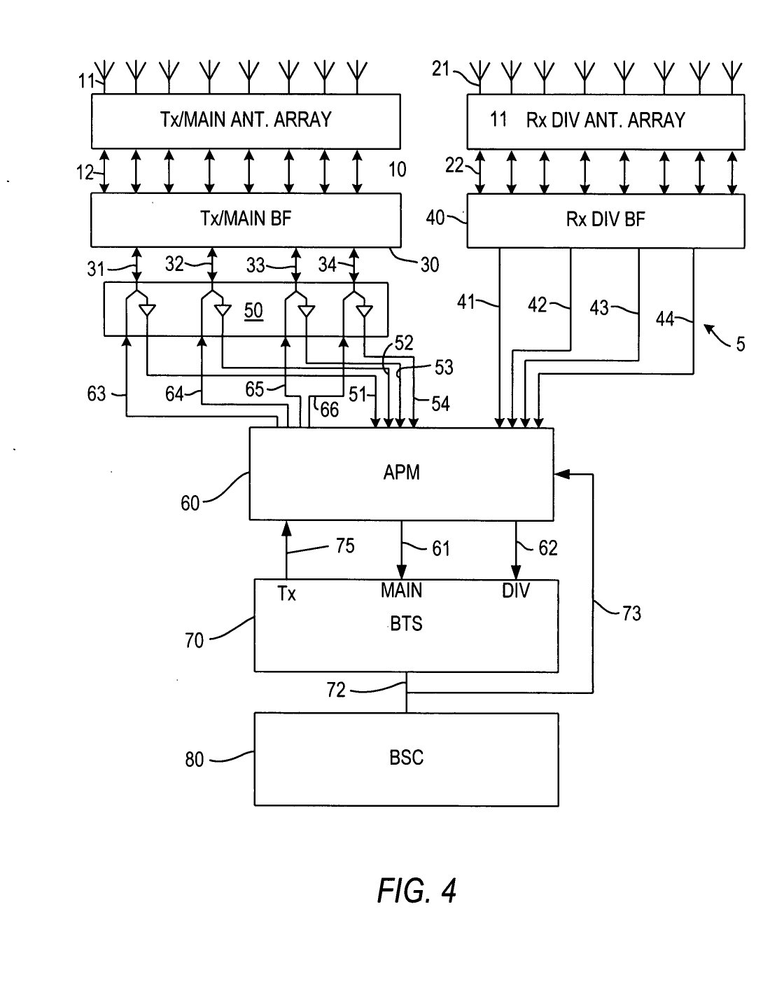

Referring now to FIG. 4, there is shown a high-level block diagram of an exemplary embodiment of a wideband appliqué implementation of an adaptive multi-beam system according to the present invention. The inventive system, shown generally at 5, comprises a pair of antenna arrays 10, 20, a pair of static beamformers 30, 40, a duplexer sub-system 50, an adaptive processor module 60 and a base transceiver station 70. The system 5 communicates in wireless fashion with a number of mobile subscribers (not shown) and with a base station controller 80, with which it is connected by an A-bis signal line 72.

The antenna arrays 10, 20 are comprised of a plurality of discrete antenna elements 11, 21 respectively. Preferably, such arrays may be in the form of an m row by n column two dimensional array. In the exemplary embodiment described, there are preferably 8 columns, each of which may comprise 12 rows of elements. The 8 columns are shown in the figure for illustration.

The antenna array 10 is, as is known in the art, used as both a transmit array and a main receive array, while the antenna array 20 is used as a diversity receive array. The diversity antenna array 20 may be spatially diverse, or preferably have a polarization orthogonal to that of the transmit/main antenna array 10, such as +45° and −45°, or horizontal and vertical polarizations. Those having ordinary skill in this art will appreciate that there may be other applicable diversity schemes employed as between the two arrays 10, 20.

Each array 10, 20 is connected with a corresponding static beamformer, 30, 40, respectively, by RF cables 12, 22 corresponding to signals received from each column of the array. Thus, in the exemplary embodiment described, each array is connected to the beamformer by 8 such RF cables.

The beamformers 30, 40 are connected by the various RF cables 12, 22 to their corresponding antenna arrays 10, 20. As well, beamformer 30 is connected by a number of RF cables 31-34 to the duplexer sub-system 50, while beamformer 40 is connected by a number of RF cables 41-44 to the adaptive processor module 60. In the exemplary embodiment shown, the number of RF cables 31-34, 41-44, corresponds to a factor of the number of columns in the corresponding array, which is preferably 2.

Each beamformer 30, 40 performs static narrow passive beamforming on the signals it receives, whereby a beam is associated with all (or a subset) of the antenna elements in its corresponding array 10, 20. The total number of beams may be a fraction of the total number of antenna elements in each antenna array, for example, ½, in the described embodiment. Such beamforming is merely for convenience and for reduction of cost. As discussed below, the beamforming could be by a larger factor or indeed constitute dynamic beamforming. However, in the described embodiment, sufficient performance gain is achieved by the adaptive processor module 60 that a simple factor of 2 narrow static beamforming will suffice.

The duplexer sub-system 50 is connected to beamformer 30 by RF cables 31-34 and to the adaptive processor module 60 by a number of RF cables 63-66, 51-54.

The duplexer sub-system 50 comprises a plurality of duplexer circuits, duplexing unidirectional downlink signals along RF cables 63-66 and uplink signals along RF cables 51-54 to form bi-directional signals to and from beamformer 30 along bi-directional RF cables 31-34. The duplexer sub-system 50 permits the transmit/main antenna array 10 to be used for both downlink communications from the base transceiver station 70 and uplink communications to the base transceiver station 70. Preferably, the duplexer sub-system 50 comprises low noise amplifiers on the uplink paths, and a plurality of MCPAs (not shown).

The adaptive processor module 60 is connected to the duplexer sub-system 50 by RF cables 51-54, 63-66, to beamformer 40 by RF cables 41-44, to the base transceiver station 60 by a plurality of transmit signal lines 71, a plurality of main receive signal lines 61 and a plurality of diversity receive signal lines 62, and by an A-bis signal line 72 that taps off A-bis information sent by the base transceiver station 70 to the base station controller 80 as described below.

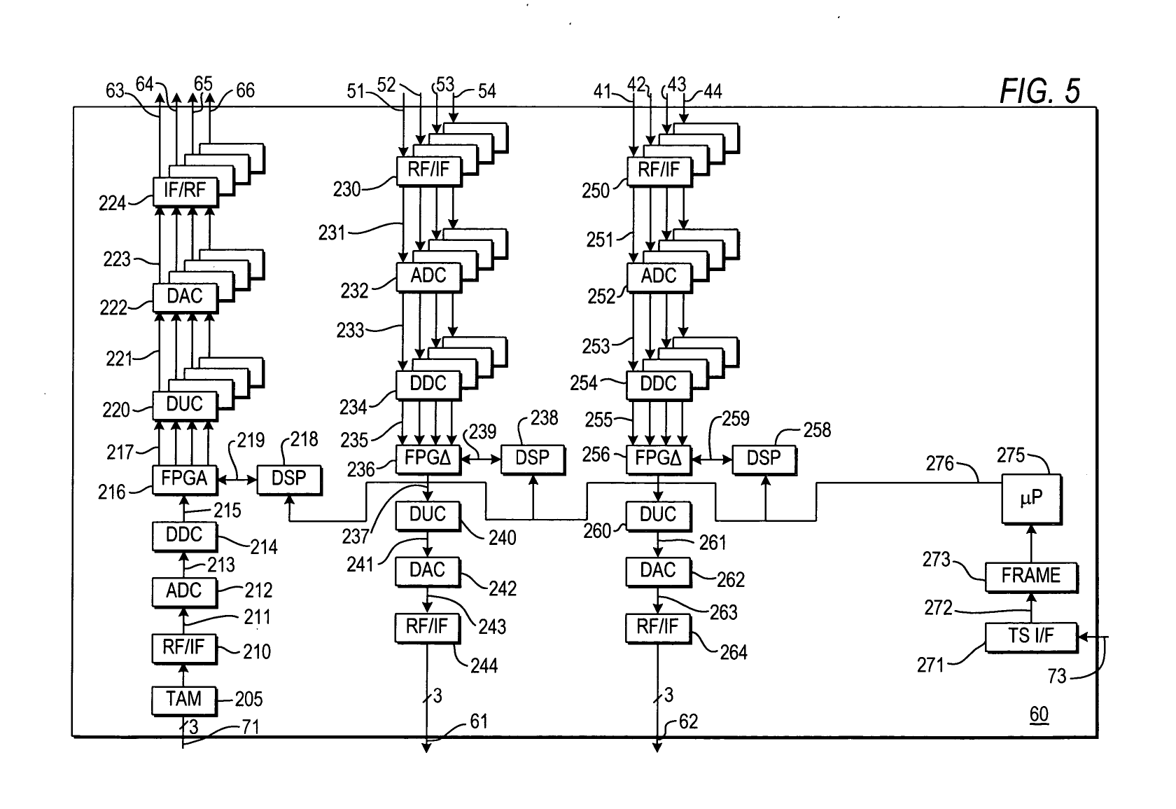

The structure of the adaptive processor module 60 is described in greater detail in FIG. 5. It comprises three distinct processing paths, designated the transmit path, the main receive path and the diversity receive path.

The transmit path comprises a transmit aggregation module 205, an RF to IF converter 210, an analog to digital converter 212, a digital down converter circuit 214, a field programmable gate array (FPGA) 216, a digital signal processor (DSP) 218, a plurality of digital up converter circuits 220, a plurality of digital to analog converters 222, and a plurality of IF to RF converters 224.

The transmit aggregation module 205 receives the RF signals along transmit signal lines 71, one corresponding to each transceiver, which, in the exemplary embodiment being described is 3 in number, aggregates the signals thereon into a single serialized RF signal and forwards the serialized RF signal along signal line 206 to the RF to IF converter 210.

The RF to IF converter 210 receives the serialized RF signal along signal line 206, converts it from RF to baseband or an intermediate frequency and forwards the resulting intermediate frequency signal along signal line 211 to the analog to digital converter 212.

The analog to digital converter 212 receives the intermediate frequency signal along signal line 211, digitizes it and forwards the resulting digital signal along signal line 213 to the digital down converter circuit 214.

The digital down converter circuit 214 receives the digital signal along signal line 213, down-converts it to baseband and forwards the resulting baseband signal along signal line 215 to the FPGA 216.

The FPGA 216 receives the baseband signal along signal line 215 and processes it. In so doing, it forwards a subset of the samples to the DSP 218 on a slot by slot basis.

The DSP 218 generates a vector of 4 digital beamforming weights corresponding to each of the 4 beams (in the exemplary embodiment being described) for the slot and returns them to the FPGA 216, which then adaptively beamforms the baseband signals in accordance with such weights and forwards the resulting baseband signal along each of the four signal lines 217 corresponding to each beam to the corresponding digital up converter circuit 220.

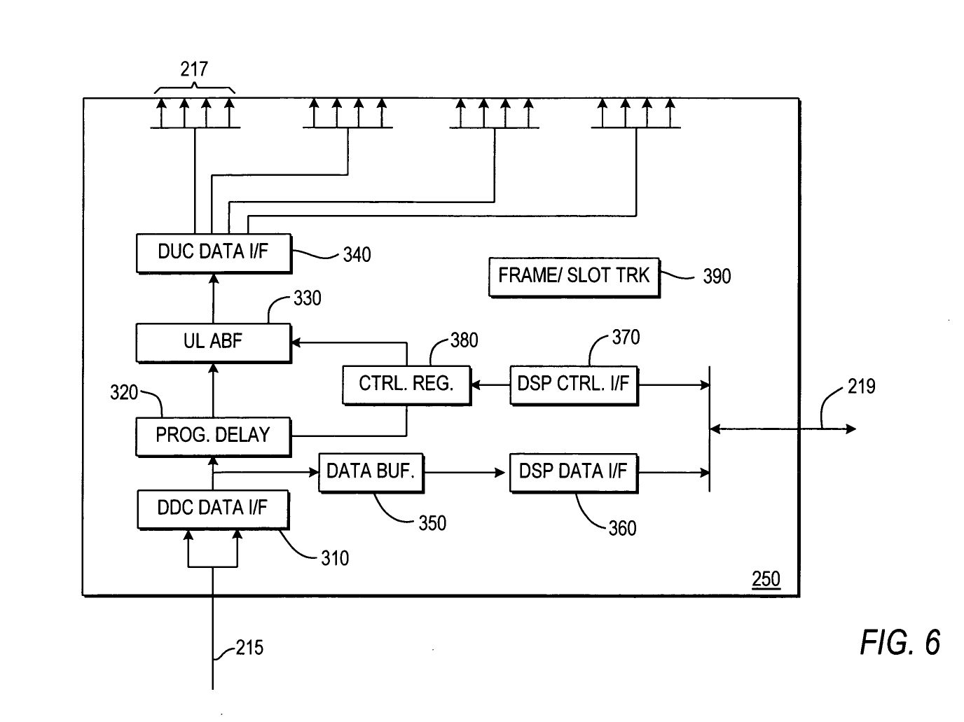

The structure of the FPGA 216 is shown in detail in FIG. 6. It comprises a DDC data interface 310, a downlink adaptive beamformer 320, a programmable delay 330, a DUC data interface 340, a data buffer 350, a DSP data interface 360, a DSP control interface 370, FPGA control registers 380 and a frame and slot tracker 390.

The DDC data interface 310 accepts the multiplexed parallel data lines corresponding to each channel from the digital down converter circuit 214, synchronises and aligns the I and Q samples from all channels and forward it to the data buffer 350.

The data buffer 350 accepts the aligned samples and stores them in first-in first-out order in preparation for sending to the DSP 218.

The DSP data interface 360 arbitrates to become master of the DSP external bus 219, and retrieves data samples from the data buffer into the internal memory of the DSP 218, organized in a slot-organized fashion. The DSP 238 retrieves 1 time slot of data at a time, for a specific user. DSP memory space is reserved for even and odd slots.

The DSP control interface 370 is a slave memory mapped interface from the DSP external bus 219, which is used by the DSP 238 to access the control registers 380 of the FPGA 236. The control registers 380 are internal FPGA registers that include such items as beamforming weights, programmed delays, synchronization control and data flow control.

The downlink adaptive beamformer 320 digitally beamforms the samples in accordance with the beamforming weights calculated by the DSP 218.

The programmable delay 320 introduces a delay from 0 to 4 sample periods (each sample is ¼ GSM baud period), independently for each carrier on each antenna path.

The DUC data interface 340 serializes the paths for each carrier and forwards the data streams d to each of the four digital up-converters 220 according to channel, along corresponding signal lines 217.

The frame and slot trackers 390 keeps track of GSM frame and slot alignment, under guidance from the optional transmit calibration path (not shown) and generates various timing signals to control frequency hopping, beamforming and data transmission to the DSP 218.

Referring once again to FIG. 5, the DSP 218 calculates the downlink digital beamforming weights to be applied by the adaptive processing module 60, in accordance with one or more applicable schemes as described herein in a later section.

Each digital up converter circuit 220 receives its corresponding baseband signal along its corresponding signal line 217, up-converts it to an intermediate frequency and forwards the resulting digital signal along its corresponding signal line 221 to the corresponding digital to analog converter 222.

Each digital to analog converter 222 receives its corresponding digital signal along its corresponding signal line 221, converts it to analog and forwards the resulting analog IF signal along its corresponding signal line 223 to the corresponding IF to RF converter 224.

Each IF to RF converter 224 receives its corresponding analog IF signal along its corresponding signal line 223, converts it to RF and forwards the resulting RF signal along its corresponding RF cable 63-66 to the duplexer sub-system 50.

The main receive path comprises, a plurality of RF to IF converters 230, a plurality of analog to digital converters 232, a plurality of digital down converter circuits 234, a field programmable gate array (FPGA) 236, a digital signal processor (DSP) 238, a digital up converter circuit 240, a digital to analog converter 242, and a IF to RF converter 244.

Each RF to IF converter 230 receives an RF signal along RF cable 51-54 from the duplexer sub-system 50, corresponding to one of the (in the exemplary embodiment being described) 4 beams, converts it from RF to baseband or an intermediate frequency and forwards the resulting intermediate frequency signal along its corresponding signal line 231 to the corresponding analog to digital converter 232.

Each analog to digital converter 232 receives its corresponding intermediate frequency signal along signal line 231, digitizes it and forwards the resulting digital signal along its corresponding signal line 233 to the corresponding digital down converter circuit 234.

Each digital down converter circuit 234 receives its corresponding digital signal along its corresponding signal line 233, down-converts it to baseband and forwards the resulting baseband signal along signal line 235 to the FPGA 236.

The FPGA 236 receives its corresponding baseband signal along its corresponding signal line 235 and processes it. In so doing, it forwards a subset of the samples to the DSP 238 on a slot by slot basis.

The DSP 238 generates a vector of 4 digital beamforming weights corresponding to each of the 4 beams (in the exemplary embodiment being described) for the slot and returns them to the FPGA 236, which then adaptively beamforms the baseband signals in accordance with such weights and forwards the resulting single baseband signal along the signal line 237 to the digital up converter circuit 240.

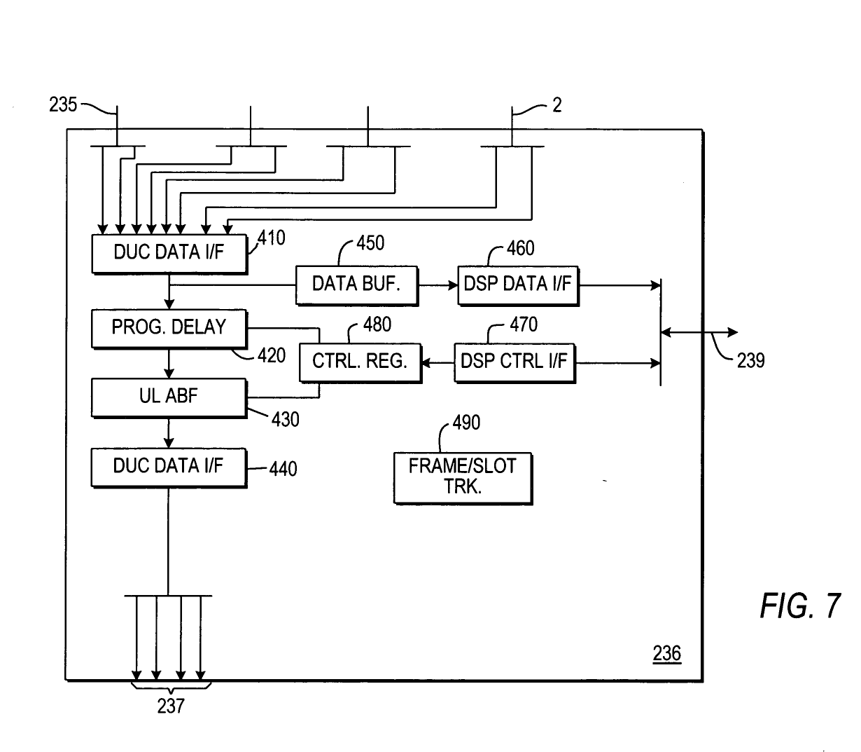

The structure of the FPGA 236 is shown in detail in FIG. 7. It comprises a DDC data interface 410, a programmable delay 420, an uplink adaptive beamformer 430, a DUC data interface 440, a data buffer 450, a DSP data interface 460, a DSP control interface 470, FPGA control registers 480 and a frame and slot tracker 490.

The DDC data interface 410 handles the multiplexed parallel data ports from each digital down-converter circuit 234, which are organized such that each quad device handles the same 4 carriers from a single antenna path, which optimizes the data bus routing.

The data is fed into data buffer 450 that stores samples in first-in-first out fashion in preparation for forwarding it to the DSP 238.

The DSP data interface 460 arbitrates to become master of the DSP external bus 239, and retrieves data samples from the data buffer 450 into the internal memory of the DSP 238, organized in a slot-organized fashion. The DSP 238 retrieves 1 time slot of data at a time, for a specific user. DSP memory space is reserved for even and odd slots.

The DSP control interface 470 is a slave memory mapped interface from the DSP external bus 239, which is used by the DSP 238 to access control registers 480 of the FPGA 236. The control registers 480 are internal FPGA registers that include such items as beamforming weights, programmed delays, synchronization control and data flow control.

The programmable delay 420 introduces a delay from 0 to 4 sample periods (each sample is ¼ GSM baud period), independently for each carrier on each antenna path.

The uplink adaptive beamformer 430 digitally beamforms the samples in accordance with the beamforming weights calculated by the DSP 238.

The DUC data interface 440 serializes the paths for each carrier and forwards the data streams to the digital up-converter 240 according to channel.

The frame and slot tracker 490 keeps track of GSM frame and slot alignment, under guidance from the optional receiver calibration path (not shown) and generates various timing signals to control frequency hopping, beamforming and data transmission to the DSP 238.

Referring once again to FIG. 5, the DSP 238 calculates the uplink digital beamforming weights to be applied by the adaptive processing module 60, in accordance with one or more applicable schemes as described herein in a later section.

The digital up converter circuit 240 receives the baseband signal along signal line 237, up-converts it to an intermediate frequency and forwards the digital signal along signal line 241 to the digital to analog converter 242.

The digital to analog converter 242 receives the digital signal along signal line 241, converts it to analog and forwards the analog IF signal along signal line 243 to the IF to RF converter 244.

Each IF to RF converter 244 receives the analog IF signal along signal line 243, converts it to RF and forwards the resulting RF signal along main receive signal lines 61 to the base transceiver station 70, organized by channels.

The diversity receive path comprises, a plurality of RF to IF converters 250, a plurality of analog to digital converters 252, a plurality of digital down converter circuits 254, a field programmable gate array (FPGA) 256, a digital signal processor (DSP) 258, a digital up converter circuit 260, a digital to analog converter 262, and a IF to RF converter 264.

Each RF to IF converter 250 receives an RF signal along RF cable 41-44 from the beamformer 40, corresponding to one of the (in the exemplary embodiment being described) 4 beams, converts it from RF to baseband or an intermediate frequency and forwards the resulting intermediate frequency signal along its corresponding signal line 251 to the corresponding analog to digital converter 252.

Each analog to digital converter 252 receives its corresponding intermediate frequency signal along signal line 251, digitizes it and forwards the resulting digital signal along its corresponding signal line 253 to the corresponding digital down converter circuit 254.

Each digital down converter circuit 254 receives its corresponding digital signal along its corresponding signal line 253, down-converts it to baseband and forwards the resulting baseband signal along signal line 255 to the FPGA 256.

The FPGA 256, whose structure is substantially as shown in FIG. 7, receives its corresponding baseband signal along its corresponding signal line 255 and processes it. In so doing, it forwards a subset of the samples to the DSP 258 on a slot by slot basis.

The DSP 258 generates a vector of 4 digital beamforming weights corresponding to each of the 4 beams (in the exemplary embodiment being described) for the slot and returns them to the FPGA 256, which then adaptively beamforms the baseband signals in accordance with such weights and forwards the resulting single baseband signal along the signal line 257 to the digital up converter circuit 260.

The digital up converter circuit 260 receives the baseband signal along signal line 257, up-converts it to an intermediate frequency and forwards the digital signal along signal line 261 to the digital to analog converter 262.

The digital to analog converter 262 receives the digital signal along signal line 261, converts it to analog and forwards the analog IF signal along signal line 263 to the IF to RF converter 264.

Each IF to RF converter 264 receives the analog IF signal along signal line 263, converts it to RF and forwards the resulting RF signal along diversity receive signal lines 62 to the base transceiver station 70, organized by channels.

The adaptive processor module 60 also comprises an A-bis sniffer module, comprising a T1 interface 271, a framer 272 and a microprocessor 275, which may be a multiple function microprocessor not dedicated to the A-bis functionality. The T1 interface 271 accepts A-bis information along an A-bis information line 73, which taps off the A-bis signal line 72. It forwards the A-bis information to the microprocessor 275. Among its various functions, the microprocessor 275 forwards relevant A-bis information to each of the DSPs 218, 238, 258 along signal line 276.

Optionally, the adaptive processor module 60 may also include a transmit calibration path (not shown) and/or a receive calibration path (not shown) for periodically calibrating the amplitude and phase of the transmit and receive paths. Loopback paths may be provided for this purpose at the static beamformer 30 and through the duplexer sub-system 50. Only unused slots are employed to convey calibration data to avoid perturbing normal traffic.

Referring once again to FIG. 4, the base transceiver station 70 is connected to the adaptive processor module 60 by transmit signal lines 71, main receive signal lines 61 and diversity receive signal lines 62. It is also connected to the base station controller 80 by an A-bis information line 72.

The base transceiver station 70 is a conventional narrowband GSM base transceiver station in that it has a transmit RF output port and main and diversity receive RF input ports. Each of such ports is characterized by a plurality of ports, corresponding to the number of channels supported by the base transceiver station. In the exemplary embodiment being described, the base transceiver station 70 comprises 3 transceivers, for each of which a channel is allocated, together with an additional channel, for a total of 4 channels.

The base transceiver station 70 transmits data intended for one of the mobile subscribers that it serves along the corresponding transmit port and receives data from one of its served mobile subscribers along the corresponding main and diversity receive ports. It makes use of the diverse signals it receives to process and hopefully provide some noise immunity to the signals it receives.

The base transceiver station 70 also forwards, as is mandated by the GSM standard employed in the exemplary embodiment, information regarding the channels used and the traffic exchanged with its mobile subscribers along the A-bis information line 72, to the base controller station 80.

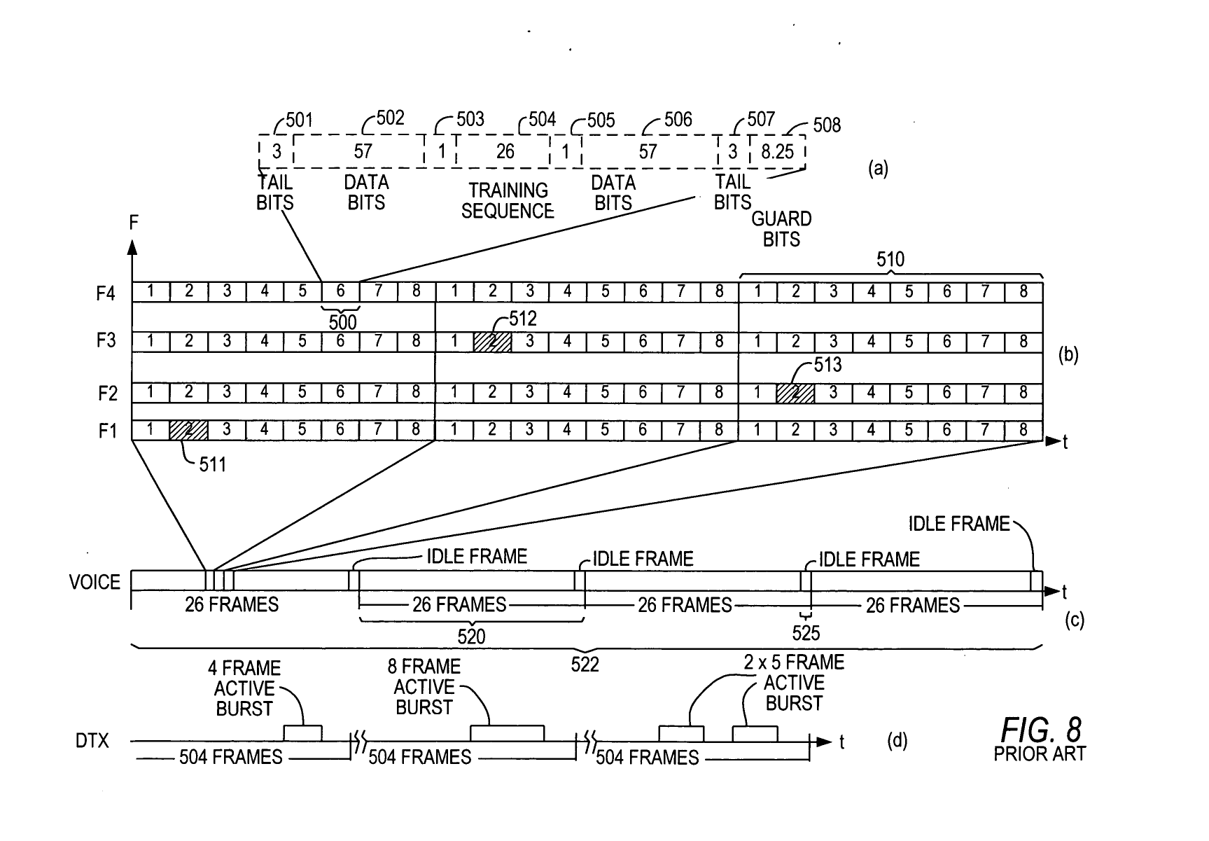

The operation of the exemplary embodiment of the inventive adaptive multi-beam system 5 will now be described. For the purposes of the following operational description, the sector housing the inventive system 5 is assumed to follow the global system for mobile communications (GSM) standard, which is well-known in the art. Salient features of this coding scheme are shown in FIGS. 8(a), 8(b) and 8(c).

The GSM standard employs a combined frequency-division multiple access (FDMA)/time-division multiple access (TDMA) scheme. That is, each frame 510 is divided into 8 slots, eg. 500 (shown in FIG. 8(b) numbered 1 through 8). A given mobile subscriber will only be assigned a single slot e.g. 511, in a frame, although it may be assigned slots in consecutive frames as shown in exemplary fashion by the shaded slots 511-513. Thus, 8 users could share one frequency channel or frame without any risk of interference.

Each of these slots 500 comprises a 155 bit packet as shown in FIG. 8(a), comprising 3 tail bits 501, a first data block of 57 data bits 502, a 26 bit (or 78 bit, depending upon the modulation o the processed channel) training sequence 504 preceded and followed by a spacer bit 503, 505, a second data block of 57 data bits 506, 3 tail bits 507 and 8.25 guard bits 508.

The training sequence (TSC) 504 is one of 8 predetermined patterns. A given cell or sector is assigned one of these patterns and all packets transmitted to and from mobile subscribers within the sector contain the assigned training sequence.

The GSM standard also allocates subsets of twenty five (25) or fifty (50) 200 kHz frequency channels within the allocated frequency GSM range of either 5 or 10 MHz to each base transceiver station 70. For example, each base transceiver station 70 comprises three transceivers (not shown), each of which at any given time transmits along a different frequency channel. Each frequency channel is associated with a separate radio. To permit a slow frequency hopping scheme, a base station transceiver will hop for each frame to a new frequency channel. The number of frequency channels allocated to the base transceiver station 70, is therefore equal to or greater than the number of transceivers. Thus, for example, as shown by the shaded slots in FIG. 8(b), a given mobile subscriber may be assigned slot 2 in each of three consecutive frames 511-513, along frequencies F1, F3, and F2 respectively.

Each slot 500 in a frame 510 may be treated separately, and may comprise a control packet, such as a BCCH (broadcast channel) or PBCCH (packet broadcast channel) control packet, a voice packet or other circuit-switched packet, or a data packet such as a general packet radio service (GPRS)/enhanced data rates for GSM Evolution (EDGE) packet. Indeed, certain slots may remain unused and not associated with any packet, to enable inter-sector handover and also because traffic is unevenly distributed throughout the day.

Each type of packet is known by the adaptive processor module 60 through its A-bis signal line 72 and may be processed differently by the adaptive processor module 60 of the present invention.

Conceptually, the frames are organized into multiframes of 26 frames 520 each. The last frame 521 of each multi-frame 520 is designated as an idle frame. In turn, the multiframes are organized into super-multiframes 522 of 4 multiframes or 104 frames each, as shown in FIG. 8(c).

Preferably, a mobile subscriber communicates in discontinuous transmission (DTX) mode, in which, when not communicating with the base transceiver station, it chooses not to transmit during specific frames to save power and also to generate less interference in the network. During such periods, the base transceiver station 70 may be nevertheless communicating with it in the downlink direction.

In DTX mode, entire super-multiframes are either active or largely silent. During DTX, however, a few frames are always transmitted along the uplink direction. Their frame number modulo 104 are constant and known. It is only during such active frame clusters (in 4, 8 or two closely separated clusters of 5 consecutive frames, depending upon the type of communication channel), that reliable information about the subscriber is known.

Armed with this information, the operation of the adaptive processor may now be described as follows. Such processing is performed on a slot by slot basis.

When a mobile subscriber (not shown) sends a packet 500 in its assigned slot in the uplink direction, it is received by each of the antenna elements 11, 21 in each of the antenna arrays 10, 20. The RF signal received by each of the antenna elements 11, 21 is forwarded to its corresponding static beamformer 30, 40, where the signals received by each pair of antenna elements within the array are statically beamformed into a single beam. Static beamforming only is performed in this preferred embodiment, for simplicity and to reduce latency within the exemplary appliqué system only, and because sufficient performance gain is achieved thereby. Nevertheless, those having ordinary skill in this art will appreciate that dynamic beamforming could be implemented without departing from the spirit and scope of the present invention.

As a result, the 8 RF signals received by the 8 antenna elements 11 in the main antenna array 10 are beamformed into 4 static beams, as are the 8 RF signals received by the 8 antenna elements 21 in the diversity antenna array 20.

The two pairs of 4 received static beams are fed into the adaptive processor module 60 (the beams from beamformer 30 being first fed into duplexer sub-system 50) as inputs on lines 51-54 and 41-44 respectively.

Within the adaptive processor module 60, the processing followed by each of the beams from beamformer 30 corresponding to the main antenna array 10 follows a similar path until they are received and processed by the FPGA 236.

In this processing path, the received beam, for example, that arrives along input line 51, is converted to baseband or an intermediate frequency by the RF/IF converter 230, digitized by the corresponding analog to digital converter 232 and digitally down-converted by the corresponding digital down converter circuit 234, whereupon it is fed into the FPGA 236.

The FPGA 236 receives each of the 4 digitally down-converted signals, separated into channels, corresponding to the 200 kHz frequency bands allocated to the base transceiver station 70. In the exemplary embodiment, the base transceiver station 70 has 3 transceivers and an additional frequency band, for a total of 4 channels, as shown in FIG. 7.

The DDC data interface 410 handles the multiplexed parallel data ports from each digital down-converter circuit 234, and feeds the data into data buffer 450.

The DSP data interface 460 retrieves data samples from the data buffer 450 into the internal memory of the DSP 238, The DSP 238 retrieves 1 time slot of data at a time, for a specific user.

The DSP 238 calculates the uplink digital beamforming weights to be applied by the adaptive processing module 60.

Digital beamforming weights are a vector of complex numbers that are to be multiplied by the signals to form a composite signal before being fed to the base transceiver station 70 (in the uplink direction). A simple weight vector is the so-called “best beam” case, where the vector comprises a single 1 corresponding to the best beam, and surrounded by 0s, which indicate that the corresponding signals are to be ignored.

The weights may change every frame for a given subscriber to reflect the adaptive nature of the present invention in tracking the desired subscriber and filtering out potential interferers. Additionally, the weights may change for different slots of the same frame since they correspond to different users.

In many of these schemes, the DSP 238 makes use of format and control information obtained from the A-bis signals 72 fed back on line 73 into the adaptive processor module 60.

Such information includes, but is not limited to site management and configuration information such as TRX transmission power level, absolute radio frequency channel number (ARFCN) list, BCCH ARFCN, base station identifier code (BSID), channel combination, hopping sequence number (HSN), mobile allocation index offset (MAIO), frequency hopping and receive diversity flags and training sequence (TSC), and connection management decoding information, such as channel activation and mode modify messages, and extracted information such as maximum timing advance, speech or data indicators, channel rate, channel type (SDCCH, full rate, half rate, multi-slot configuration), radio sub-channel (half rate channel 0, half rate channel 1), starting time, and optional information such as DTX support for uplink and downlink and GSM time.

Preferably, the A-bis processing is compliant with BSC-BTS interface layer 3 specifications of the supported vendor and take into account vendor-specific implementations.

Those having ordinary skill in this art will readily appreciate that the A-bis information is specific to the preferred GSM environment. However, other comparable information sources may be available for other coding schemes as well.

Such information is processed by the A-bis sniffer module (tapping onto T1 interface 271), comprising a framer 273 and microprocessor 275, feeding the extracted information to each DSP 218, 238, 258. However, as discussed below, one piece of information not obtainable through A-bis is whether a super multi-frame is active or inactive.

The DSP control interface 470 is accessed by the DSP 238 access the control registers 480 of the FPGA 236 to store the beamforming weights.

In the interim, the programmable delay 420 introduces a delay in sample periods (each sample is ¼ GSM baud period), independently for each carrier on each antenna path. The delay corresponds to the deterministic time to transfer the data to the DSP 238, compute the weights and return them to the FPGA 236.

When the programmable delay 420 has expired, the uplink adaptive beamformer 430 digitally beamforms the samples in accordance with the beamforming weights calculated by the DSP 238. Thereupon the paths for each carrier are serialized by the DUC data interface 440 and the data streams forwarded to the digital up-converter 240 according to channel.

The digital up-converter 240 upconverts the digital data to an intermediate frequency and feeds it to the digital to analog converter 242, whereupon it is digitized and then fed to the IF/RF converter 244, where it is converted into a RF frequency suitable for reception by the main receiver input along signal 61 of the base transceiver station 70.

The processing followed by the beams from beamformer 40 corresponding to the diversity antenna array 20 follows a similar but parallel path until a single RF signal is received and processed by the diversity input along signal 62 of the base transceiver station 70.

The processing followed by transmit outputs from the base transceiver station 70 along input 71 in the downlink direction is similar, but effectively in reverse. The RF signal to be transmitted is converted to baseband or an intermediate frequency by the RF/IF converter 210, digitized by the analog to digital converter 212 and digitally down-converted by digital down converter circuit 214, whereupon it is fed into the FPGA 236.

The FPGA 216 receives the digitally down-converted signal, separated into channels, as shown in FIG. 6. The DDC data interface 310 handles the multiplexed parallel data ports from the digital down-converter circuit 214.

The DDC data interface 310 handles the multiplexed parallel data ports from the digital down-converter circuit 214, and feeds the data into data buffer 350.

The DSP data interface 360 retrieves data samples from the data buffer 350 into the internal memory of the DSP 218, The DSP 218 retrieves 1 time slot of data at a time, for a specific user.

The DSP 218 calculates the uplink digital beamforming weights to be applied by the adaptive processing module 60.

The DSP control interface 370 is accessed by the DSP 218 access the control registers 380 of the FPGA 216 to store the beamforming weights.

The uplink adaptive beamformer 330 digitally beamforms the samples in accordance with the beamforming weights calculated by the DSP 218.

In this case, the programmable delay 320 is unrelated to any deterministic time to transfer the data to the DSP 218, compute the weights and return them to the FPGA 216. In most scenarios, the weights be slightly adjusted, but are nevertheless based on the same channel parameter, namely average power, which is substantially time-invariant over a few samples. Rather, the delay is used for unrelated purposes, such as randomly offsetting the signals slightly to avoid signal cancellation if the hardware is not calibrated.

Thereupon the paths for each carrier are serialized by the DUC data interface 340 and the data streams forwarded to each of the four digital up-converters 220 according to channel and beam.

Each digital up-converter 220 upconverts the digital data to an intermediate frequency and feeds it to a corresponding digital to analog converter 222, whereupon it is digitized and then fed to a corresponding IF/RF converter 224, where it is converted into an RF frequency suitable for transmission. The RF signal is fed through the duplexer sub-system 50 and forwarded to the static beamformer 30 and eventually to the transmit antenna array 10.

The present invention makes use of the knowledge of information relating to the form and content of the data, obtained through the A-bis interface 72 from the base transceiver station 70 to the base station controller 80 to craft the digital beamforming weights in accordance with the type of packet in each slot and the prevailing environment.

For example, control packets such as BCCH and DBCCH packets are to be sent to all possible mobile subscribers within the sector. Therefore, knowing, from the A-bis information, that a slot is allocated to a control packet, means that such slot should be broadcast to all subscribers. This is done by adopting a weighting system that covers the entire sectors, such as by equal weighting all the fixed beams. In any event, features such as beamforming, power control and DTX are forbidden for the entirety of frames in which a control packet such as BCCH and PBCCH packets appear.

Unused channels may be similarly treated, or may, indeed, be assigned a zero weight for each beam, signifying the absence of any digital beamforming.

In respect of voice packets, or other voice-like circuit-switched data packets, the digital beamforming algorithm performs three distinct functions. First, the time of arrival of the signal on every beam node is determined. Second, the presence or absence of channel activity is identified. Third, the best beam(s) are identified and weights defined to maximize the signal performance accordingly.

These three functions are achieved by measuring the average power of the correlation response between the slot and a reference signal S_{TS}, defined as a sampled version of the modulated training sequence applicable to the sector in question.

Like many features, the training sequence (TSC) 504 is typically not communicated to the adaptive processor module 60 by the base transceiver station 70, as it is to mobile subscribers. Thus, the adaptive processor module 60 attempts to “mirror” the functionality of a mobile subscriber in order to obtain such information, or else obtain it by some other means.

In the case of the training sequence (TSC) 504, it may be obtained from the A-bis information on line 72, or else obtained by trying each of the eight possible training sequences on a downlink signal that is free from noise and interference when it reaches the adaptive processor module 60.

A-bis information may also provide information regarding call numbering and the slow frequency hopping algorithm, which may be calculated with knowledge from A-bis of the HSN, MA list, MAIO and frame number (FN) parameters.

The frame number is not generally accessible from A-bis, but synchronization by means of FCCH an the synchronization channel (SCH) decoding, which repeats a known 64-bit pattern every 10 frames, will permit this parameter, as well as the frame boundary, to be extracted by simple correlation from the information bits, for the downlink direction (and concomitantly for the uplink direction, after taking into account a 3 time slot offset and the deterministic signal path delays of the adaptive processor module 60), especially since, unlike a mobile subscriber, the adaptive processor module 60 is directly connected to the base transceiver station 70 and therefore, not subject to fading channels, co-channel interference or degraded signal to noise ratio experienced by wireless channels. Unlike downlink synchronization, the objective of uplink synchronization is to track time of arrival changes due to propagation channel and motion by the mobile. Coarse timing compensation is in any event accomplished by the Timing Advance feature of the GSM standard.

In order to improve the timing sychronization, while not unduly burdening the DSP, the signal transmitted from an FPGA to its corresponding DSP has a small multiple of the sampling rate (either 2 or 4 times). The reference signal S_{TS} for the correlation is generated by convolving the training sequence with a pulse-shaping filter such as a GMSK linearized filter and sampling it, to generate a 26×1 digital vector having the basic GSM sampling rate. As a consequence of the foregoing, the dominant part of the channel will be included in the reference signal S_{TS}, and the digital beamforming will tend to be optimal in many practical scenarios. Oversampling the reference signal S_{TS} by a factor of 2 or 4, to give a 52×1 or 104×1 vector, is also possible. However, any increased accuracy of timing synchronization does not usually justify such additional complexity.

Then, taking for example, the uplink direction, a correlation coefficient c_{K}(i,j) for each received digital sample i from each of the four beam streams j in one of the main or diversity processing paths (which operate in parallel) is calculated for each frame k, between the digital sample and the training sequence is computed.

Then, a power coefficient is computed as
pₖ(i,j)=|c_{K}(i,j)|² (1)
and is used for averaging over time, so that the averaged power in frame k is given by
Pₖ(i,j)=λₖPₖ₋₁(i,j)+(1−λₖ)pₖ(i,j) (2)
where λ_{K} is a filter coefficient for robustness. The value of λ_{K} depends upon the status of the frame, that is, whether it is active or inactive. From simulations, it would appear that preferable values of λ_{K} may be 0.7 when the subscriber's signal was present during the processed frame and 0.9 when it was absent. Nevertheless, those having ordinary skill in this art will appreciate that the values of λ_{K} may be tuned in field trials to achieve optimal performance.

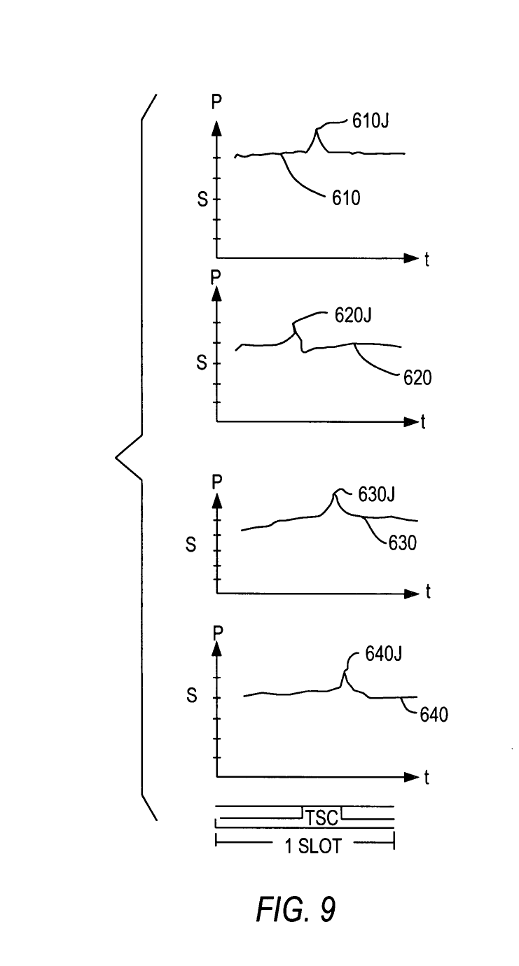

An exemplary plot of Pₖ(i,j) as a function of time t is shown for a typical slot for each of the four beam streams j in FIG. 9. This figure shows that the presence of the training sequence incorporated into the reference signal is signified by a spike 611, 621, 631, 641 in the average power response.

It may be seen that the training sequence (TSC) 504 is not detected by each of the beam streams at the identical point, having regard to multi-path and other effects well known to those having ordinary skill in the art.

Practically, for purposes of identifying the starting point, it is usually sufficient to consider only a window of about 7 GSM samples (14 or 28 samples, corresponding to oversampling factors of 2 and 4 respectively) relatively evenly allocated before and after the presumed position of the training sequence (TSC) 504. This corresponds to the assumption that an active mobile subscriber may be expected to span the guard period of ±3 symbols. Depending upon the coverage area and the type of propagation, this may be further constrained in certain circumstances.

Nevertheless, the deviation in the starting point may be determined and taken into account in processing. As discussed below, if the digital weights calculated incorporate some measure of combining, it may be preferable to actually time-align the signals prior to so doing so that the delay spread of the channel will decrease.

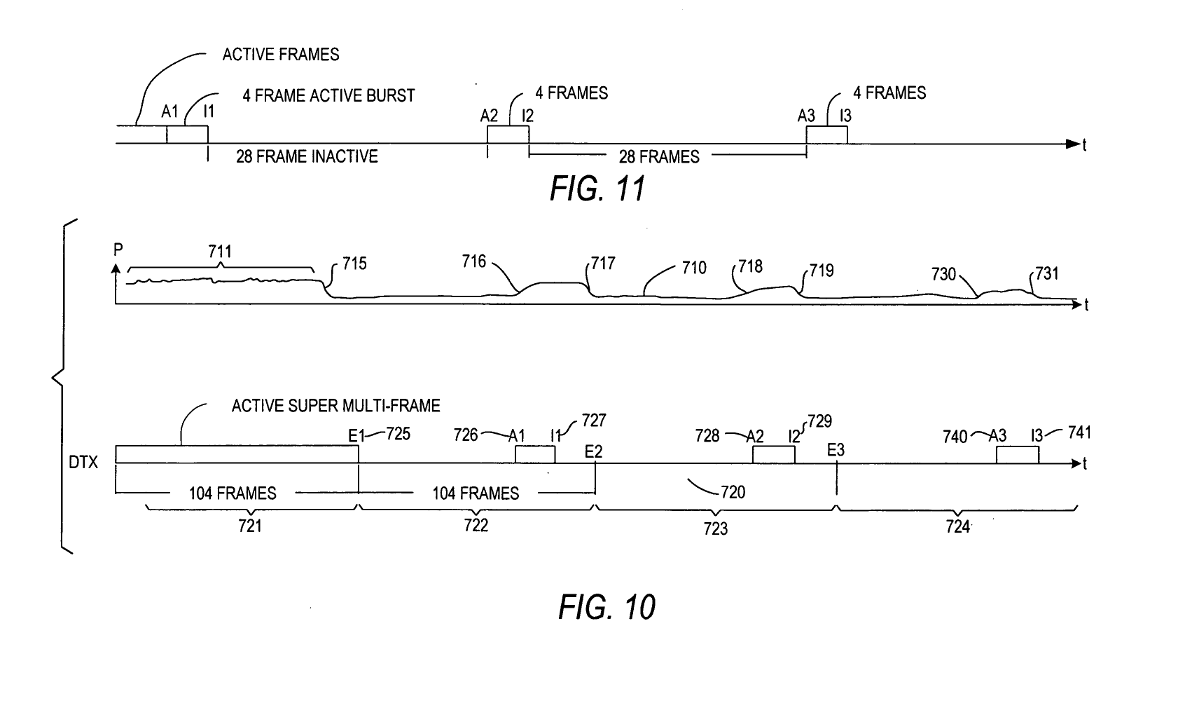

The second step of activity detection may also be performed using this average power function Pₖ(i,j). FIG. 10 shows a plot of Pₖ(i,j) 710 as a function of time t for a single beam stream, vertically overlaid over a timing diagram of a series of super multi-frames 721-724. In the figure, the power function 710 corresponding to the active super multi-frame 721 shows a level of activity characterized by spikes corresponding to the training sequence (TSC) 504 of each slot. At the end of the active super multi-frame 721, shown as point E₁ 725, there is shown a downward transition 715. Thereafter, upward transitions 716, 718, 730 are shown corresponding to the presence of multiple frame activity bursts at the same point in each super multi-frame, designated A₁ 726, A₂ 728, A₃ 740 as well as downward transitions 717, 719, 731 corresponding to the end of the multiple frame activity bursts and the resumption of the inactivity period, designated I₁ 727, I₂ 729, I₃ 741 respectively. Thus, activity may be detected by simply comparing the average power function starting just a few frames before the point in the super multi-frame where such activity bursts are to take place. Operationally, if the current activity status is not known, it is assumed to be in DTX or inactive mode and proved wrong by the absence of the expected upward and downward transitions.

The third step of beam selection, for active slots, may also be performed using the average power function Pₖ(i,j), which is a substantially time-invariant parameter of the wireless communication channel. Turning again to FIG. 9, it may be seen that the top-most plot shows a TSC spike 611 with the greatest average power, signifying that the stream corresponding to this beam is likely the best beam. Therefore, from analysis of the values of the average power function Pₖ(i,j) of the TSC spikes 611, 621, 631, 641 for each of the four beam streams j, the relative strengths may be discerned and appropriate digital beamforming weights may be derived.

It should be noted that signal responses from co-channel interferers will likely be disregarded, because there will be little correlation between the training sequence of such interferer and the reference signal S_{TS}. However, because the training sequences are not orthogonal, the interferer may not entirely disappear. The use of slow frequency hopping may also serve to attenuate the effects of such interference.

It is anticipated that the present invention will likely be deployed in dense urban environments where angular spread is sufficiently high to cause the best beam to change from one beam to another for consecutive frames. In the described appliqué system, latency issues mean that the current digital beamforming coefficients will not apply to the current frame, so that one would expect to experience significant performance degradation in such environments, if simplistic beam selection decisions were made.

The present invention achieves optimal performance when the probability of having a dominant beam is maximized so that the best beam of the main and diversity branches are fed to the base transceiver station. In such case, any interferer falling outside the dominant beam will have been cancelled.

If an interference rejection combining (IRC) approach, such as is known in the art is applied, any interferer occurring on the same beam as the desired subscriber could be attenuated or cancelled.

Indeed, by the cascade of three operations found in the present invention, namely the static analog beamforming at the antenna by the beamformers 30, 40, beam selection and/or combining at the adaptive processor module 60 and interference rejection combining at the base transceiver station 70, one would expect that most of the interference would be cancelled.

While conceivably, higher order diversity could be applied at the base transceiver station 70, those having ordinary skill in this art will appreciate that the present invention, with its combined beamforming/diversity gain may equal or exceed even 4 branch diversity, particularly if interference rejection combining is not applied at the base transceiver station 70.

If the desired subscriber's signal seems to be well-received across more than one beam, one may choose, rather than simply choosing the strongest beam, to perform some kind of maximum ratio combining (MRC) so that the best beam is preferentially weighted over other contributing beams. Before engaging in such beam combining, it is preferable to time align the signals so that the delay spread of the channel will decrease and the performance of the Viterbi equalizer in the base transceiver station will increase.

On the other hand, if combining is not performed, for example, because of latency issues in an appliqué system such as is shown in FIG. 4, it may be more appropriate not to time align the streams, so as to minimize the possibility of signal cancellation.

In any event, any multi-path effects will be dealt with conventionally by the Viterbi receiver in the base transceiver station 70.

Because the main and diversity signal paths are processed independently, it may be possible to reach different decisions as to whether to apply best beam selection or beam combining, and in what form.

Indeed, it is conceivable that the receive diversity branch has a different number of beams than the main receive branch. In the limiting case, a sector antenna may be used for the diversity branch. Because in such a case, no signal processing is performed, the RF cable 22 could bypass the adaptive processor module 60 entirely and be directly connected to the base transceiver station 70. This would enhance system reliability by providing a signal path to the base transceiver station 70 that is independent of the adaptive processor module 60, but at a cost of degraded beamforming performance, which may be at least somewhat compensated by the beamforming gain from the main receive path.

Preferably, the weights determined in the main processing path in the uplink direction will also be applied in the downlink direction, since the channel will act reciprocally for most parameters of interest, such as angle of arrival, time delays and average power per path.

On the other hand, the phases of the respective uplink and downlink paths may be uncorrelated and may result in the combined signal components having a different effective direction. In such situations, beam combining may minimize such phase effects. More precisely, the transmitted signal may be split into multiple streams, each with similar weights to those estimated in the uplink channel that is, more than one beam node, possibly with some amplitude weighting. In so doing, the mobile subscriber should receive the transmitted signal with sufficient power to properly decode the received signal irrespective of how the multi-path components combine. Nevertheless, in such a high interference environment, it may be preferable to simply select the best beam.

While the foregoing is appropriate for active channels, inactive or DTX channels do not provide sufficient traffic to justify using the same approach. Nevertheless, while there is only minimal traffic in the uplink direction, there may be significant downlink traffic, for which downlink digital beamforming weights will be calculated, preferably from corresponding uplink digital beamforming weights.

In such a circumstance, it may be more appropriate to consider only those known active frames in the average power calculation, preferably with equal weighting:
P^{DTX}ₖ(i,j)=P^{DTX}ₖ₋₁(i,j)+pₖ(i,j) (3)
where P^{DTX}ₖ(i,j) is initialized before every cluster of active frames in DTX mode, namely before points A₁ 726, A₂ 728, A₃ 740 shown in FIG. 10. In Equation (3), the robustifying coefficient μ_{K} is discarded, because of the paucity of samples.

As well, the value of P^{DTX}ₖ(i,j) at the end of an active super multi-frame, that is, at point E₁ 725 and at the end of the cluster of active frames I₁ 727, I₂ 727, I₃ 741 is retained or “frozen”. The last recorded frozen power value is then used for all inactive frames in the cluster, until the end of the cluster is reached, at which point, the newly calculated value of P^{DTX}ₖ(i,j) is calculated and saved as the new frozen value.

Thus, for example, the value of Pₖ(i,j) calculated at point E₁ 725 is used from point E₁ 725 until point I₁ 727, and values of P^{DTX}ₖ(i,j) are calculated for points A₁ 726 through I₁ 727. At point I₁ 727, a new value of P^{DTX}ₖ(i,j) is frozen and used until point A₂ 727 is reached. Between points A₁ 726 and I₁ 727, the weights could be dynamically changed for each frame. However, since the accumulated information may not be sufficiently robust, it may be preferable to continue using the previous frozen values for these few active frames as well.

For proper classification of a super multi-frame as active or inactive, it is preferable to wait for a few frames so that active-to-inactive or inactive-to-active transitions between consecutive super multi-frames are properly detected. The length of such transition period depends upon channel type but should be less than 20 frames. During such transition period, frozen values may be used. For a new call, and in the absence of any information sector beam weighting could be used.

Those having ordinary skill in this art may argue that during inactive frames in the DTX mode, there may be some discontinuity in multi-path components, so that dominant paths may disappear and re-appear, without the possibility of detection during the small cluster of active frames. If this is of concern, a combining scheme in which weaker beams are given reduced weight so as to generate “artificial sidelobes” may be applied. Such an approach will resolve any concern about propagation discontinuities, but at the cost of a degradation of the average performance of the system.

In adaptive multi-rate (AMR) channels, the channel's performance is sufficiently good that a given user will only appear in a particular time slot of every other frame. Also, in the AMR half-rate mode, DTX mode may start and stop at any time, and is not constrained to start at a super multi-frame boundary. In such scenario, however, a periodicity of active frames is maintained, on the basis of 4 frames every 32 frames. Thus, the methodology described above for DTX frames may be simply adjusted to take account of such different periodicity, as shown in FIG. 11.

Finally, data packets for GPRS/EDGE subscribers may be specifically treated by a number of potential schemes. The particular attributes of such data packets are that the uplink and downlink traffic is asymmetric, which is not the case for voice packets.

In particular, in the GSM standard, GPRS/EDGE packets are transmitted in a session, defined by a transport format identifier (TFI), for which certain slots in a given frame are reserved in both the uplink and downlink paths.

In order to reserve such slots, a series of 3 bits, known as USF bits are communicated in packets to all mobile subscribers using GPRS/EDGE packets in a data session allocated to the same frame, indicating which time slots within the frame are available for use for data packets. Thus, some information in the downlink direction is to be broadcast to all subscribers in the sector, while other downlink information, comprising the user-specific data packets, may be only selectively broadcast.

Thus, while uplink data packets may be treated like voice packets, as described previously, downlink packets may demand different treatment.

Perhaps the simplest mechanism to handle downlink data packets is to apply sector beam weighting, much like control packets, whether on an all-beam or subset basis for all downlink communications and any other appropriate beam weighting for uplink communications.

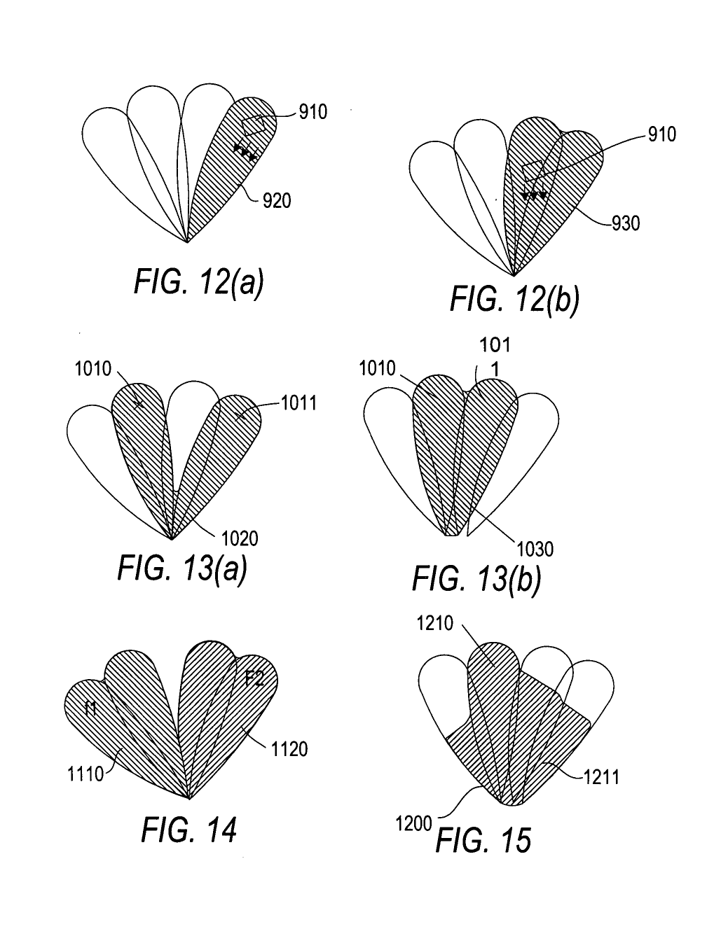

A first alternative mechanism is suitable where it is known off-line that all of the GPRS/EDGE subscribers are served by a beam or a subset of beams, such as is shown in FIGS. 12(a) and (b), where, for example, a single building 910 is known to be the source of all GPRS/EDGE data packet communications in the sector. In such a circumstance, such knowledge could be appropriated by applying an appropriate best beam or beam subset weighting, with improved signal performance, signified by the exemplary shaded beam coverage patterns 920, 930. This scenario benefits from the fact that all active GPRS/EDGE subscribers will decode USF bits.

A second alternative mechanism is a variation of the first alternative. It relies on the fact that setting up a TFI session involves a modicum of set-up and will result in the information being communicated by A-bis data. Thus, rather than obtaining knowledge about data packet users on an off-line basis, such knowledge about GPRS/EDGE users, shown in FIGS. 13(a) and (b) as 1010 and 1011, may be obtained by the adaptive processor module 60 on a dynamic basis, with similar processing as shown to achieve, by way of example, beam coverage patterns 1020 and 1030.

A third alternative mechanism is a link established/failure mechanism. It relies resource re-allocation, a procedure applied to mobile subscribers who are experiencing connection trouble for a relatively long time.

In this mechanism, the beams are divided into a plurality of subsets 1110, 1120, as is shown in FIG. 14, and each subset is allocated a separate frequency band, F1 and F2 respectively. For every frame along a given frequency, a few slots will be dedicated to data packets.

Thus, if a GPRS/EDGE packet is communicated to or from a mobile subscriber along a given beam subset in which the subscriber is situated, the communication will be made with some improvement in signal performance.

On the other hand, if the packet is communicated to or from a subscriber who is not well served by the beam subset, the communication will fail and the cell reselection procedure will be invoked. Such procedure will result in the subscriber returning to the same cell, at which point, the resource allocation process treats the communication as if it is suffering from severe fading, and will switch the allocated frequency for the subscriber. This will have the effect of moving the subscriber to another beam subset, which eventually will cause the subscriber to be associated with the proper beam subset. The use of beam subsets thus provides some measure of signal performance improvement.

Such a mechanism makes use of the fact that there are no handover procedures for data and that a data packet may more easily tolerate transmission delays in the event of failure, unlike voice packets.

Such mechanism is also applicable when a subscriber moves within a sector, triggering an intra-sector handover from one beam coverage area to another.

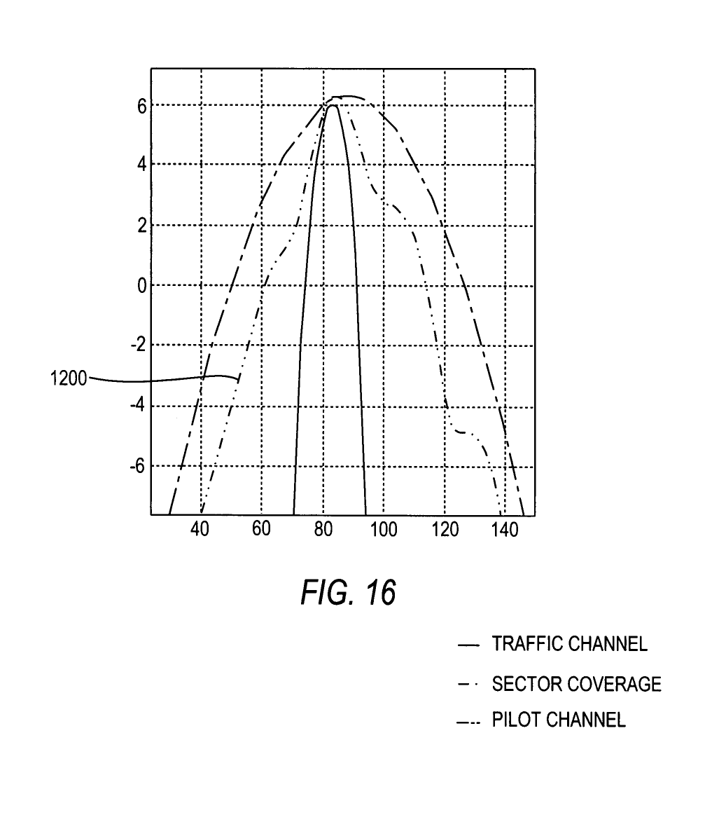

Finally, a truly adaptive mechanism may be used for downlink communications, as shown in FIGS. 15 and 16. In such circumstance, a beam weighting using the best beam for the particular data user with an attenuated version (by about 3-4 dB) of all remaining beams is applied to all downlink communications. In this fashion, the signal performance for the data packet will be improved, while all other subscribers in the sector will be able to detect the USF bits.

Until now, only an appliqué, wideband system using passive antenna arrays has been considered. Those having ordinary skill in this art will readily appreciate that the present invention could, with only minor modification, be extended to embedded systems, to narrowband systems and to systems using active antenna arrays.

In an embedded system, the adaptive processing module would be integral with the base transceiver station. In such a scenario, the processing blocks between the FPGAs and the base transceiver station interface in FIG. 5 could be dispensed with, as there would be no cause to convert the digital baseband samples to an analog RF signal only to be reconverted to a digital baseband sample within the base transceiver station.

Additionally, there would be no A-bis sub-system, as the A-bis information would be known to the base transceiver station 70. Further, most base transceiver stations make use of FPGAs and corresponding DSPs, and excess capability on such components could be appropriated, potentially dispensing with such additional components.

Accordingly, an embedded implementation could result in significant economies, which may be advantageous. As well, any concerns with latency issues, that may exist in an appliqué solution would likely not be an issue in such an embedded implementation. This may free up processing time that could, for example, accommodate dynamic beamforming outside the adaptive processor module 60.

A narrowband implementation would have the advantage of higher system reliability, in that the performance of the system would not be dependent upon a single component, such as the transmit aggregation module 205 or a power amplifier. There would be some small economy of power, as combining losses at the transmit aggregation module would be avoided. However, such losses are generally considered insignificant, having regard to the attenuation that all of the downlink signals undergo in the adaptive processor module 60 in any event.

Such an implementation would have a separate and parallel processing path for each transceiver. Thus, for a base transceiver station with three transceivers, the 3 processing paths of the adaptive processing module of FIG. 5 would be tripled to 9 processing paths. Clearly, the cost of additional reliability is, as is often the case, additional component complexity.

Finally, the present invention may easily be adapted to incorporate the emerging active antenna systems in which MCPAs are distributed among the elements. The predominant advantage of active antenna systems is that IF cabling between the adaptive processing module 60 and the antenna arrays 10, 20 may be used rather than RF cabling, to reduce losses. Additionally, IF cables can be easily bundled together. Further, the adaptive processor module 60 for such active antenna systems would benefit from some component economy, as the IF to RF converters at the beamformer side would be obviated.

Also, although not shown, between the adaptive processor module 60 and the beamformer 30, a series of MCPAs is typically inserted, for example, as part of the duplexer sub-system 50. With an active array, larger numbers of smaller versions of power amplifiers and low-noise amplifiers are integrated within the array to provide the desired gain and reliability while disposing of such MCPAs.

We claim:

1. An adaptive multi-beam system associated with a base transceiver station for transmitting transmit data to and receiving receive data from a mobile subscriber of the base transceiver station, comprising:
at least one receive antenna array of antenna elements adapted to receive analog radio frequency (RF) receive signals containing the receive data;
a receive beamforming network adapted to receive the analog RF receive signals and to generate at least one fixed narrow received beam therefrom;
an information source for providing information on the form and content of the transmit and receive data;
a receive adaptive processor sub-system adapted to receive the at least one fixed narrow received beam, to convert the at least one fixed narrow received beam into received beam data for at least one frequency channel, to generate a plurality of receive adaptive weights from at least one substantially time-invariant parameter of a channel between the mobile subscriber and the at least one receive antenna array, using form and content information of the receive data from the information source, whereby the received beam data is combined to maximize reception of the receive data and/or rejection of undesired signals having a common frequency and time slot therewith, and to forward the combined received beam data to the base transceiver station;
a transmit adaptive processor sub-system adapted to obtain the transmit data from the base transceiver station, to generate transmit adaptive weights from the at least one channel parameter using form and content information of the transmit data and of previous receive data from the information source, to apply the transmit adaptive weights to the transmit data, whereby transmit beam data is generated to maximize reception by the mobile subscriber of the transmit data and/or rejection of undesired signals having a common frequency and time slot;
a transmit beamforming network adapted to receive the transmit beam data and to generate at least one narrow transmit beam therefrom; and
a transmit antenna array of antenna elements adapted to transmit analog RF transmit signals incorporating the at least one narrow transmit beam for receipt by the mobile user.

2. An adaptive multi-beam system according to claim 1, wherein the at least one receive antenna array comprises a main antenna array and a diversity antenna array.

3. An adaptive multi-beam system according to claim 1, wherein the information source obtains the information after processing by the base transceiver station.

4. An adaptive multi-beam system according to claim 3, wherein the information source is an A-bis processor.

5. An adaptive multi-beam system according to claim 2, wherein the receive beamforming network comprises a main beamforming network and a diversity beamforming network.

6. An adaptive multi-beam system according to claim 5, wherein the transmit beamforming network is connected with one of the main beamforming network and the diversity beamforming network.

7. An adaptive multi-beam system according to claim 2, wherein the main antenna array and the diversity antenna array have mutually orthogonal polarizations.

8. An adaptive multi-beam system according to claim 2, wherein the main antenna and the diversity antenna array are spatially diverse.

9. An adaptive multi-beam system according to claim 3, wherein the transmit antenna array is common with one of the main antenna array and the diversity antenna array.

10. An adaptive multi-beam system according to claim 9, further comprising a duplexer disposed between the adaptive processor sub-system and the transmit beamforming network and the receive beamforming network sub-system.

11. An adaptive multi-beam system according to claim 1, wherein the receive beamforming network comprises a plurality of fixed beamforming weights.

12. An adaptive multi-beam system according to claim 1, wherein the receive adaptive processor sub-system comprises a digital signal processor for generating the receive adaptive weights from the received beam data.

13. An adaptive multi-beam system according to claim 12, wherein the receive adaptive processor sub-system comprises a field programmable gate array for applying the receive adaptive weights to the received beam data.

14. An adaptive multi-beam system according to claim 12, wherein the receive adaptive processor sub-system comprises an RF to intermediate frequency (IF) converter module for converting the received beam data from the RF domain to an intermediate domain for processing by the digital signal processor.

15. An adaptive multi-beam system according to claim 12, wherein the receive adaptive processor sub-system comprises an analog to digital conversion module for converting the received beam data from analog into digital form for processing by the digital signal processor.

16. An adaptive multi-beam system according to claim 12, wherein the receive adaptive processor sub-system comprises a down conversion module for converting the received beam data to baseband for processing by the digital signal processor.

17. An adaptive multi-beam system according to claim 12, wherein the receive adaptive processor sub-system comprises an up conversion module for converting the combined receive data to an intermediate frequency after processing by the digital signal processor.

18. An adaptive multi-beam system according to claim 12, wherein the receive adaptive processor sub-system comprises a digital to analog converter module for converting the combined receive data to analog form after processing by the digital signal processor.

19. An adaptive multi-beam system according to claim 12, wherein the receive adaptive processor sub-system comprises an IF to RF converter module for converting the combined receive data to the RF domain after processing by the signal processor.

20. An adaptive multi-beam system according to claim 1, wherein the transmit adaptive processor sub-system comprises a digital signal processor for processing the transmit adaptive weights.

21. An adaptive multi-beam system according to claim 20, wherein the transmit adaptive processor sub-system comprises a field programmable gate array for applying the transmit adaptive weights to the transmit data.

22. An adaptive multi-beam system according to claim 20, wherein the transmit adaptive processor sub-system comprises an RF to intermediate frequency (IF) converter module for converting the transmit data from the RF domain to an intermediate domain for processing by the digital signal processor.

23. An adaptive multi-beam system according to claim 20, wherein the transmit adaptive processor sub-system comprises an analog to digital conversion module for converting the transmit data from analog into digital form for processing by the digital signal processor.

24. An adaptive multi-beam system according to claim 20, wherein the transmit adaptive processor sub-system comprises a down conversion module for converting the transmit data to baseband for processing by the digital signal processor.

25. An adaptive multi-beam system according to claim 20, wherein the transmit adaptive processor sub-system comprises an up conversion module for converting the transmit beam data to an intermediate frequency after processing by the digital signal processor.

26. An adaptive multi-beam system according to claim 20, wherein the transmit adaptive processor sub-system comprises a digital to analog conversion module for converting the transmit beam data to analog form after processing by the digital signal processor.

27. An adaptive multi-beam system according to claim 20, wherein the transmit adaptive processor sub-system comprises an IF to RF converter module for converting the transmit beam data to the RF domain after processing by the signal processor.

28. An adaptive multi-beam system according to claim 1, wherein the transmit beamforming network comprises a plurality of fixed beamforming weights.

29. An adaptive multi-beam system according to claim 1, wherein the transmit antenna array is passive.

30. An adaptive multi-beam system according to claim 1, wherein the transmit antenna array is active.

31. An adaptive multi-beam system according to claim 1, wherein the at least one receive antenna array is passive.

32. An adaptive multi-beam system according to claim 1, wherein the at least one receive antenna array is active.

33. An adaptive multi-beam system according to claim 1, wherein the number of the at least one fixed narrow receive beam is a fraction of the number of antenna elements in the at least one receive antenna array.

34. An adaptive multi-beam system according to claim 1, wherein the number of the at least jone fixed narrow transmit beam is a fraction of the number of antenna elements in the transmit antenna array.

35. An adaptive multi-beam system according to claim 1, wherein the receive adaptive processor sub-system is embedded within the base transceiver station.

36. An adaptive multi-beam system according to claim 1, wherein the transmit adaptive processor sub-system is embedded within the base transceiver system.

37. An adaptive multi-beam system according to claim 1, wherein the at least one substantially time-invariant channel parameter is average channel power.

38. A method of receiving receive data at a base transceiver station having at least one receive antenna array of antenna elements from a mobile subscriber thereof and of transmitting transmit data from the base transceiver station along a transmit antenna array of antenna elements associated therewith to the mobile subscriber, comprising the steps of:
(a) receiving analog RF receive signals containing the receive data at each of the antenna elements of the receive antenna array;
(b) generating at least one fixed narrow receive beam from the analog RF receive signals received at each of the antenna elements of the at least one receive antenna array;
(c) converting each of the at least one fixed narrow receive beam into digital base bend received beam data;
(d) obtaining information on the form and content of the transmit and receive data;
(e) generating a plurality of receive adaptive weights from at least one time-invariant parameter of a channel between the mobile subscriber and the at least one receive antenna array, using the form and content information of the receive data, whereby the received beam data is combined to maximize reception of the receive data and/or rejection of undesired signals having a common frequency and time slot therewith;
(f) forwarding the combined receive data to the base transceiver station;
(g) obtaining the transmit data from the base transceiver station;
(h) generating a plurality of transmit adaptive weights from the at least one channel parameter using the form and content information of the transmit data and of previous receive data, whereby transmit beam data is generated from the transmit adaptive weights and a digital baseband form of the transmit data to maximize reception by the mobile subscriber of the transmit data and/or rejection of undesired signals having a common frequency and time slot;
(i) beamforming the transmit beam data into at least one fixed narrow transmit beam;
(j) forwarding the at least one fixed narrow transmit beam to the antenna elements of the transmit antenna array, and
(k) transmitting, through each of the antenna elements of the transmit antenna array, an analog RF transmit signal incorporating the at least one fixed narrow transmit beam to the mobile subscriber.

39. A method of receiving and transmitting according to claim 38, wherein step (e) comprises correlating the received beam data against a reference signal.

40. A method of receiving and transmitting according to claim 39, further comprising applying the correlated received beam data to identify a data boundary therein.

41. A method of receiving and transmitting according to claim 39, further comprising calculating an average power function from the correlated received beam data for each of the beams.

42. A method of receiving and transmitting according to claim 41, further comprising applying the average power function to detect activity in an uplink channel between the mobile subscriber and the base transceiver station.

43. A method of receiving and transmitting according to claim 41, further comprising calculating the receive adaptive weights based on the average power function.

44. A method of receiving and transmitting according to claim 41, further comprising calculating the transmit adaptive weights based on the average power function.

45. A method of receiving and transmitting according to claim 38, wherein step (e) comprises calculating the adaptive weights to provide a downlink beam coverage pattern that maximizes reception of the transmit data by the mobile subscriber while broadcasting system information to any other mobile subscribers.
